(19) United States
(12) Patent Application Publication
(10) Pub. No.: US 2016/0112976 A1
(43) Pub. Date: Apr. 21, 2016

(54) ESTIMATION OF SPUR PARAMETERS IN WIRELESS COMMUNICATIONS

(71) Applicant: QUALCOMM Incorporated, San Diego, CA (US)

(72) Inventor: Hassan Rafique, Farnborough (GB)

(21) Appl. No.: 14/630,386

(22) Filed: Feb. 24, 2015

Related U.S. Application Data
(60) Provisional application No. 62/064,123, filed on Oct. 15, 2014.
(60) Provisional application No. 62/064,113, filed on Oct. 15, 2014.

(51) Int. Cl. H04W 56/00; H04L 5/00; H04W 72/12

(52) U.S. Cl. CPC H04W 56/003; H04W 72/1231; H04L 5/0005; H04L 5/0062

(57) ABSTRACT

Aspects of the present disclosure provide for an apparatus configured to receive a communication signal including a spur utilizing a communication interface. The apparatus determines a first estimated frequency of the spur and a first estimated duration of the spur based on the first estimated frequency utilizing a searching algorithm. The apparatus determines a second estimated frequency of the spur based on the first estimated duration utilizing the searching algorithm, and a second estimated duration of the spur based on the second estimated frequency utilizing the searching algorithm. The apparatus determines at least one of an amplitude, a start location, or a phase offset of the spur based on the second estimated frequency and the second estimated duration.

### CROSS-REFERENCE TO RELATED APPLICATIONS

This application claims priority to and the benefit of provisional patent application nos. 62/064,123 and 62/064,113 both filed in the United States Patent and Trademark Office on 15 Oct. 2014, the entire contents of these applications are incorporated herein by reference.

### TECHNICAL FIELD

The technology discussed below relates generally to wireless communication systems, and more particularly, to detection and estimation of spurs or tones.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Packet Access (HSPA), which provides higher data transfer speeds and capacity to associated UMTS networks.

Spurs or spurious signals are narrowband noise that can undesirably affect the communication between wireless communication devices such as base stations and mobile terminals. At a mobile terminal, spurs can emanate from the oscillator and related circuitry used for clocking and tuning purposes. They can be realized as complex tones that can interfere with the desired signal, directly or indirectly. In the context of adjacent-channel interference (ACI) detection, spurs may cause false alarms and invoke signal processing algorithms that are not suitable for that scenario, which can compromise ACI performance. Furthermore, during channel acquisition, spurs may get detected as potential frequency correction channel tones coming from a base station and can delay the acquisition process due to unnecessary synchronization channel scheduling.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method of determining spur parameters in a communication signal operable by an apparatus. The apparatus receives a communication signal including a spur utilizing a communication interface. The apparatus determines a first estimated frequency of the spur. The apparatus determines a first estimated duration of the spur based on the first estimated frequency utilizing a searching algorithm. The apparatus determines a second estimated frequency of the spur based on the first estimated duration utilizing the searching algorithm. The apparatus determines a second estimated duration of the spur based on the second estimated frequency utilizing the searching algorithm. The apparatus determines at least one of an amplitude, a start location, or a phase offset of the spur based on the second estimated frequency and the second estimated duration.

Another aspect of the disclosure provides an apparatus configured to determine spur parameters in a communication signal. The apparatus includes means for receiving a communication signal including a spur. The apparatus further includes means for determining a first estimated frequency of the spur, and means for determining a first estimated duration of the spur based on the first estimated frequency utilizing a searching algorithm. The apparatus further includes means for determining a second estimated frequency of the spur based on the first estimated duration utilizing the searching algorithm, and means for determining a second estimated duration of the spur based on the second estimated frequency utilizing the searching algorithm. The apparatus further includes means for determining at least one of an amplitude, a start location, or a phase offset of the spur based on the second estimated frequency and the second estimated duration.

Another aspect of the disclosure provides an apparatus configured to determine spur parameters in a communication signal. The apparatus includes a communication interface, a computer-readable medium including a spur parameters estimation code, and at least one processor coupled to the communication interface and the computer-readable medium. The at least one processor when executing the spur parameters estimation code, is configured to receive a communication signal including a spur utilizing the communication interface. The at least one processor is further configured to determine a first estimated frequency of the spur, and a first estimated duration of the spur based on the first estimated frequency utilizing a searching algorithm. The at least one processor is further configured to determine a second estimated frequency of the spur based on the first estimated duration utilizing the searching algorithm, and a second estimated duration of the spur based on the second estimated frequency utilizing the searching algorithm. The at least one processor is further configured to determine at least one of an amplitude, a start location, or a phase offset of the spur based on the second estimated frequency and the second estimated duration.

Another aspect of the disclosure provides a computer-readable medium including code for causing an apparatus to determine spur parameters in a communication signal. The code causes the apparatus to receive a communication signal including a spur utilizing a communication interface. The code further causes the apparatus to determine a first estimated frequency of the spur, and a first estimated duration of the spur based on the first estimated frequency utilizing a searching algorithm. The code further causes the apparatus to determine a second estimated frequency of the spur based on the first estimated duration utilizing the searching algorithm, and a second estimated duration of the spur based on the second estimated frequency utilizing the searching algorithm. The code further causes the apparatus to determine at least one of an amplitude, a start location, or a phase offset of the spur based on the second estimated frequency and the second estimated duration.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of an apparatus operable to detect spurs and estimate spur parameters in accordance with aspects of the disclosure.

FIG. 2 is a drawing illustrating spur classifications and impact according to some aspects of the disclosure.

FIG. 3 shows two graphs illustrating the fast Fourier transform (FFT) of a spur and a non-spurious signal spur according to some aspects of the disclosure.

FIG. 4 is another graph illustrating the spur of FIG. 3 standing out from the non-spurious signal when both signals are shown in the same graph.

FIG. 5 is a graph illustrating the FFT of a 200 kHz spur and a 200.5 kHz spur according to some aspects of the disclosure.

FIG. 6 is a graph illustrating the FFT of a 200.4 kHz spur sampled at a frequency of 270.833×4 kHz.

FIG. 7 is a flow chart illustrating a spur parameters determination method in accordance with some aspects of the disclosure.

FIG. 8 is a graph illustrating examples of estimated rough values of a spur duration according to a cost function.

FIG. 9 is a flow chart illustrating a rough spur duration determination method in accordance with some aspects of the disclosure.

FIG. 10 is a flow chart illustrating a fine spur frequency determination method in accordance with some aspects of the disclosure.

FIG. 11 is a flow chart illustrating a fine spur duration determination method in accordance with some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

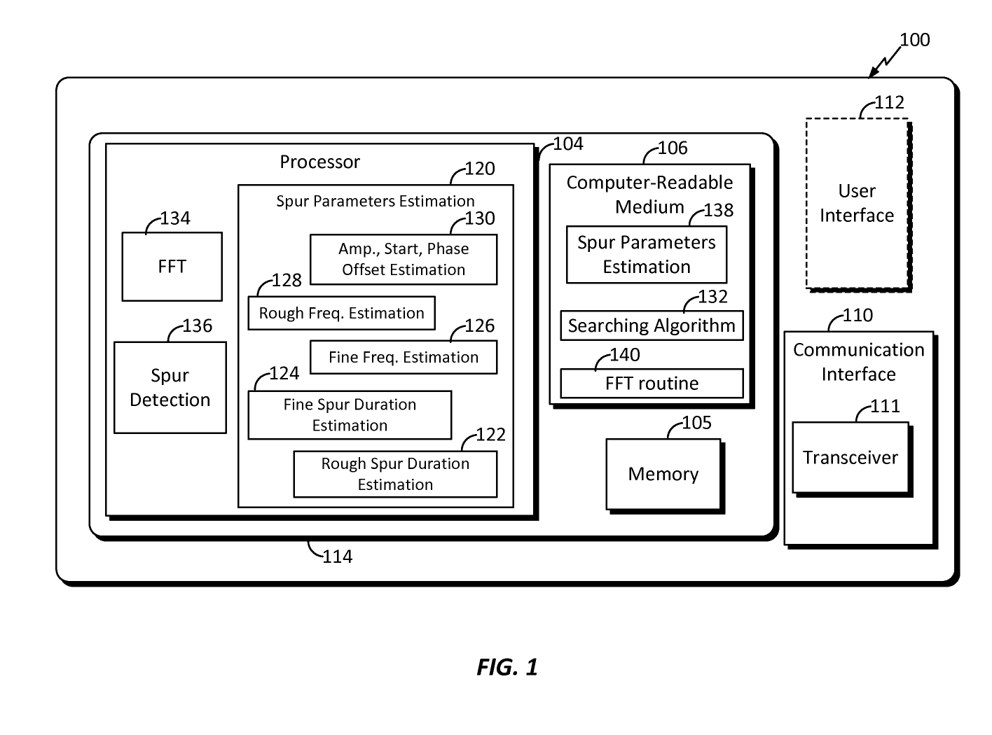

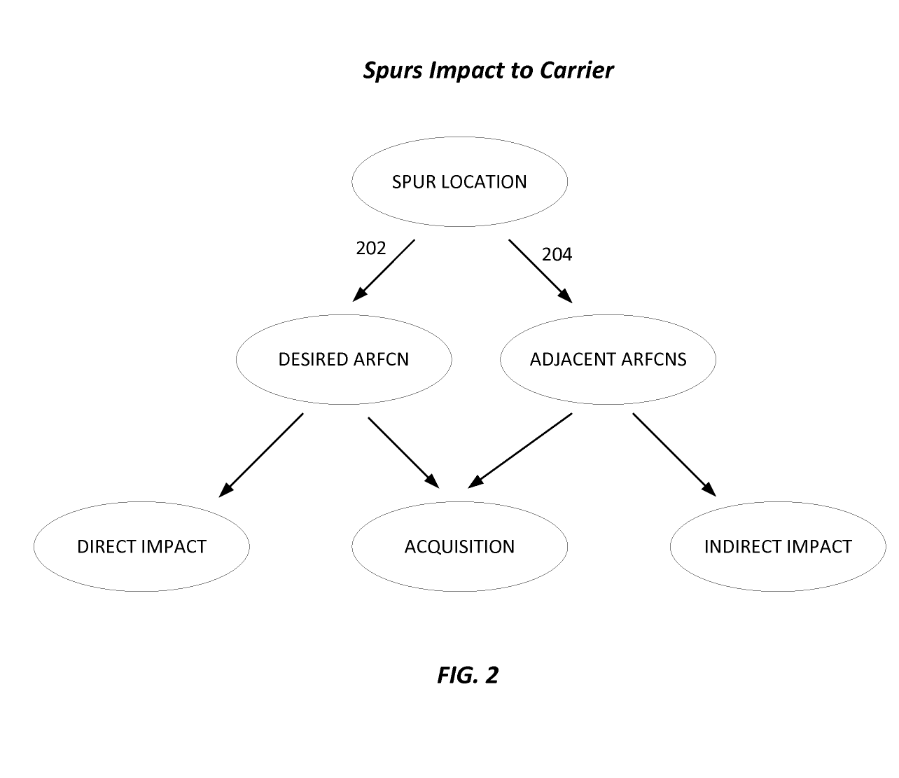

FIG. 1 is a diagram illustrating an example of an apparatus 100 operable to detect spurs and estimate spur parameters in accordance with aspects of the disclosure. In accordance with various aspects of the disclosure, an element, or any portion of an element, or any combination of elements may be implemented with a processing system 114 that includes one or more processors 104. For example, the apparatus 100 may be a user equipment (UE). In another example, the apparatus 100 may be a radio network controller (RNC) or a base station. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. For example, the processor 104, as utilized in an apparatus 100, may be used to implement any one or more of the processes and functions described below and illustrated in FIGS. 2-11. In various aspects of the disclosure, the components, modules, circuitry, and/or blocks of the apparatus 100, shown or not shown in FIG. 1, may be implemented in software, hardware, firmware, or a combination thereof.

In this example, the processing system 114 may be implemented with a bus architecture utilizing a bus. The bus may include any number of interconnecting buses and bridges depending on the specific application of the processing system 114 and the overall design constraints. The bus links together various circuits including one or more processors (represented generally by the processor 104), a memory 105, and computer-readable media (represented generally by the computer-readable medium 106). The bus may also link various other circuits such as timing sources, peripherals, voltage regulators, and power management circuits, which are well known in the art, and therefore, will not be described any further. A bus interface provides an interface between the bus and a communication interface 110 including, for example, a transceiver 111 and other known circuitry in the art for wireless communications. The communication interface 110 provides a means for communicating (e.g., transmitting and receiving wireless signals) with various other apparatus over a transmission medium. Depending upon the nature of the apparatus, a user interface 112 (e.g., keypad, display, speaker, microphone, joystick, touchscreen, touchpad, gesture sensor) may also be provided.

The processor 104 includes a spur parameters estimation block 120 that can be configured to perform various functions to estimate the parameters of a spur or spurious signal in a communication signal, which may be received via the communication interface 110. In one aspect of the disclosure, the spur parameters estimation block 120 includes a rough spur duration estimation block 122, a fine spur duration estimation block 124, a fine spur frequency estimation block 126, and a rough spur frequency estimation block 128. The spur parameters estimation block 120 further includes an ASP estimation block 130 for determining spur amplitude, start position, and phase offset. The rough spur duration estimation block 122 may be configured to determine a rough estimate of the spur duration using a searching algorithm 132. The fine spur duration estimation block 124 may be configured to determine a fine estimate of the spur duration using a searching algorithm. The fine spur frequency estimation block 126 may be configured to determine a fine estimate of the spur frequency using a searching algorithm. The rough spur frequency estimation block 128 may be configured to determine a rough estimate of the spur frequency. The searching algorithm 132 may be stored in the computer-readable medium 106 or the processor 104. The various blocks (122, 124, 126, and 128) of the spur parameters estimation block 120 may utilize the same or different searching algorithm.

The processor 104 also includes a fast Fourier transform (FFT) block 134 that can be configured to perform FFT operations on signal samples to generate frequency domain data. A spur detection block 136 may be configured to detect the presence of spurs in a communication signal. The above components or blocks will be described in more detail below in some illustrative examples.

The computer-readable medium 106 may include a spur parameters estimation routine 138 that when executed by the processor 104, can configure the spur parameters estimation block 120, FFT block 134, and spur detection block 136 to perform various functions, for example, to detect, estimate and/or determine the parameters of a spur or a tone. In some aspects of the disclosure, the spur parameters estimation block 120 may be configured to estimate or determine the frequency, amplitude, duration, start time, and/or phase offset of a spur or a tone. The computer-readable medium 106 may include an FFT routine 140 when executed by the processor 104, can configure the FFT block 134 to perform various FFT functions on signal data.

The processor 104 is also responsible for managing the bus and general processing, including the execution of software stored on the computer-readable medium 106. The software, when executed by the processor 104, causes the processing system 114 to perform the various functions described below for any particular apparatus. The computer-readable medium 106 may also be used for storing data that is manipulated by the processor 104 when executing software. For example, the computer-readable medium 106 may be used to store signal samples of a communication signal received by the apparatus, and other data generated or utilized by the processor 104.

One or more processors 104 in the processing system may execute various software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 106 may reside in the processing system 114, external to the processing system 114, or distributed across multiple entities including the processing system 114. The computer-readable medium 106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

FIG. 2 is a drawing illustrating examples of spur classifications and impact in accordance with aspects of the disclosure. In a first scenario 202, if a spur or spurious signal is located at or near a carrier of a desired absolute radio-frequency channel number (ARFCN), the spur may directly impact such carrier and its acquisition. In a second scenario 204, if a spur is located at or near the carriers of adjacent ARFCNs, the spur may still indirectly impact the desired ARFCN and its acquisition.

Aspects of the disclosure provide a method that can detect a spur and estimate the spur (or tone) parameters given that the existence of the spur is known. Non-limiting examples of the spur parameters are frequency, amplitude, duration, start time, and phase offset. The existence of spurs may be determined by using any suitable methods or processes. In one example, a method for determining the existence of spurs is disclosed in a co-pending patent application, titled Adjacent-Channel Interference and Spur Handling in Wireless Communications (Attorney Docket No. 146416, application Ser. No. ______), filed on even date herewith in the United States Patent and Trademark Office, which is incorporated herein in its entirety by reference.

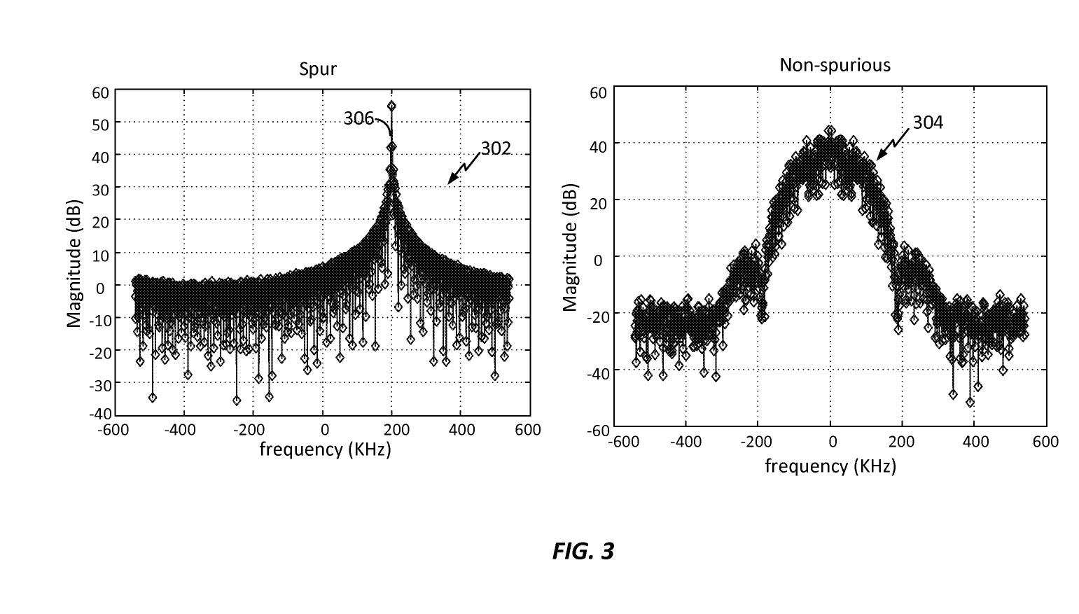

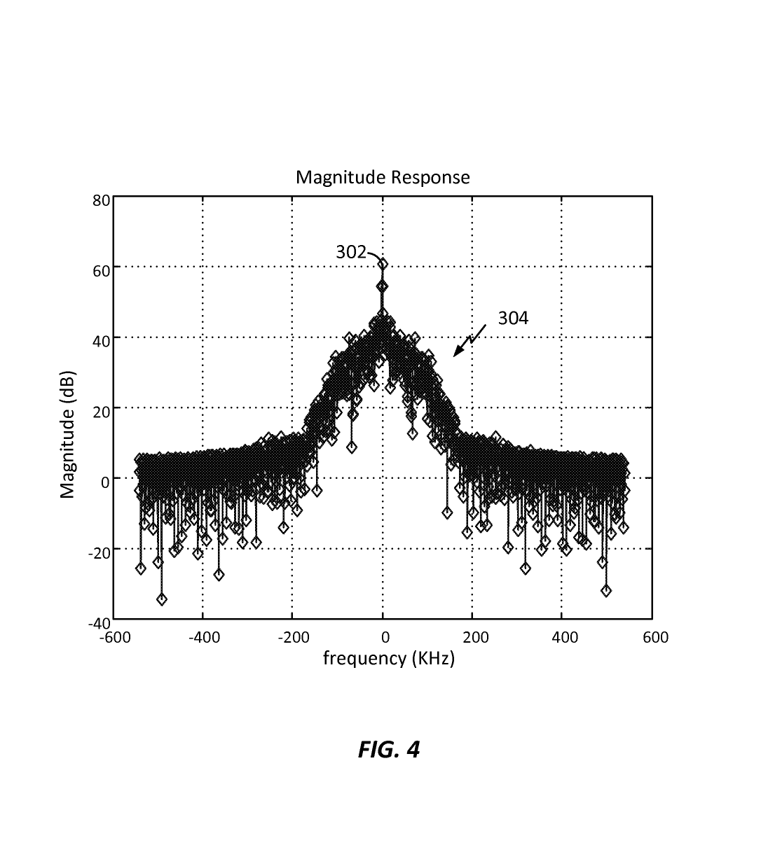

A spur is monotonic in nature and have its energies concentrated around its frequency. FIG. 3 are two graphs illustrating the magnitude responses of a spur 302 and a non-spurious signal 304 in accordance with an aspect of the disclosure. The energy gradient of the spur 302 against frequency is quite steep relative to that of the non-spurious signal 304. When compared to the non-spurious signal 304 (e.g., a GSM carrier), it can be seen that the spur 302 has a substantially more prominent peak 306, which can be considered an outlier among the data set. FIG. 4 is another graph illustrating the spur 302 standing out from the non-spurious signal 304 when both signals are shown in the same graph.

In one aspect of the disclosure, the spur 302 or a spurious signal can be detected by utilizing a peak to average ratio (PAR) computed in the frequency domain as defined by equation (1) below. The spur detection block 136 may be utilized to perform the below described processes to detect a spur based on PAR.

Let the FFT of the signal x[n] samples be X[k] as shown in equation (0). FFT or discrete Fourier transform (DFT) may be used interchangeably in this specification.

$$\begin{matrix}X [ k ] = {\sum }_{n = 0}^{N - 1} x [ n ] {e}^{- j 2 π \frac{k}{N} n } & ( 0 ) \\ k : 0 , 1 , … N & \end{matrix}$$

In equation (0), X[k] is the frequency domain data of the signal x[n]. Then, the PAR can be computed as follows:

$$PAR = \frac{max ( \vert X [ k ] \vert )}{\frac{1}{k 2 - k 1 + 1} {\sum }_{k = k 1}^{k 2} \vert X [ k ] \vert} .$$

N is the FFT windows size, k1 is the FFT bin start, and k2 is the FFT bin end. A bin is a spectrum sample, and defines the frequency resolution of the FFT window. When the PAR is greater than a spur detection threshold (e.g., a predetermined threshold), it indicates that spur is detected. In one example, the spur detection threshold may be set to about 10 dB or any suitable value.

A spur can be represented in the time domain as equation (1).

$$x [ n ] = A {e}^{j ( 2 π \frac{{F}_{spur}}{{F}_{s}} n + ϕ ) } n \text{:} a , a + 1 , a + 2 , … a + \overline{N} - 1 \qquad ( 1 )$$

In equation (1), a is the start of the spur in unit of time (e.g., an offset from a measurement period where the spur starts, N̅ is the duration, Fₛₚᵤᵣ is the spur frequency, Fₛ is the sampling frequency, N is the fast Fourier transform (FFT) window size, and φ is the initial phase offset. Taking the FFT of the time domain equation (1), produces the following equations.

$$\begin{matrix}X [ k ] = {\sum }_{n = 0}^{N - 1} x [ n ] {e}^{- j2π \frac{k}{N} n} k \text{:} 0 , 1 , … N & ( 2 ) \\ X [ k ] = {\sum }_{n = a}^{a + \overline{N} - 1} A {e}^{j ( 2 π \frac{{F}_{spur}}{{F}_{s}} n + ϕ )} {e}^{- j 2 π \frac{k}{N} n} \\ X [ k ] = {\sum }_{n = a}^{a + \overline{N} - 1} {Ae}^{j [ 2 π n ( \frac{{F}_{spur}}{{F}_{s}} \frac{k}{N} ) + ϕ ]} , let α = \frac{{F}_{spur}}{{F}_{s}} - \frac{k}{N} \\ X [ k ] = {\sum }_{n = a}^{a + \overline{N} - 1} A {e}^{j [ 2 π n α + ϕ ]} \\ x [ k ] = A {e}^{jϕ} [ {e}^{j 2 παα} + {e}^{j 2 π ( α + 1 ) α} + {e}^{j 2 π ( α + 2 ) α} … + {e}^{j2π ( α + \overline{N} - 1 ) α} ] & \end{matrix}$$

Taking e^{j2παα} as a common term, X[k] can be simplified.

$$\begin{matrix}X [ k \} = A {e}^{j ϕ} {e}^{j 2 παα} [ 1 + {e}^{j 2 π α} + {e}^{j 4 πα} … + {e}^{j 2 π ( \overline{N} - 1 ) α} ] \\ X [ k ] = A {e}^{j ϕ} {e}^{j 2 παα} \frac{1 - {e}^{j 2 πα \overline{N}}}{1 - {e}^{j 2 πα}} \\ X [ k ] = A {e}^{j ϕ} {e}^{j 2 π αα} {e}^{j πα \overline{N}} \frac{{e}^{- jπα \overline{N}} - {e}^{jπα \overline{N}}}{{e}^{j πα} ( {e}^{- jπα} - {e}^{j π α} )} & \\ X [ k ] = A {e}^{j [ π α ( \overline{N} + 1 + 2 α ) + ϕ ]} \frac{sin ( πα \overline{N} )}{sin ( π α )} & ( 2.1 ) \\ \vert X [ k ] \vert = A \frac{sin ( π α \overline{N} )}{sin ( π α )} & ( 3 ) \\ θ [ k ] = π α ( \overline{N} - 1 + 2 α ) + ϕ & ( 4 )\end{matrix}$$

Where |X[k]| is the magnitude, and θ[k] is the phase.
Now, substitute

$$α = \frac{{F}_{spur}}{{F}_{s}} - \frac{k}{N}$$

in equation (4) and rearrange the terms of the equation to get equation (5).

$$\begin{matrix}θ [ k ] = - k \frac{π ( \overline{N} - 1 + 2 α )}{N} + {F}_{spur} \frac{π ( \overline{N} - 1 + 2 α )}{{F}_{s}} + ϕ \\ θ [ k ] = - km + C , \\ where , & ( 5 ) \\ m = \frac{π ( \overline{N} - 1 + 2 α )}{N} & ( 6 ) \\ C = {F}_{spur} \frac{π ( \overline{N} - 1 + 2 α )}{{F}_{s}} + ϕ & ( 7 )\end{matrix}$$

From the above equations (2) through (7), the five unknown spur parameters are A, Fₛₚᵤᵣ, N̅, a, and φ. Therefore, the spur can be estimated by determining these five spur parameters. According to aspects of the disclosure, these five unknown parameters can be solved by using a searching algorithm for determining the values of Fₛₚᵤᵣ and N̅, followed by solving the remaining unknowns using equations (4) and (6). The searching algorithm may be any suitable algorithm that can be utilized to find the values of Fₛₚᵤᵣ and N̅. In one aspect of the disclosure, using the values of kₘₐₓ and kₘₐₓ₊₁ of the spur spectrum, the searching algorithm may be implemented as a cost function (8) shown below.

$$C ( k , {F}_{spur} , \overline{N} ) = arg min \{ {F}_{spur} , \overline{N} \} \vert \frac{\vert X [ {k}_{max} + 1 ] \vert}{\vert X [ {k}_{max} ] \vert} - \frac{\vert R [ {k}_{max} + 1 ] \vert}{\vert R [ {k}_{max} ] \vert} \vert \qquad ( 8 )$$

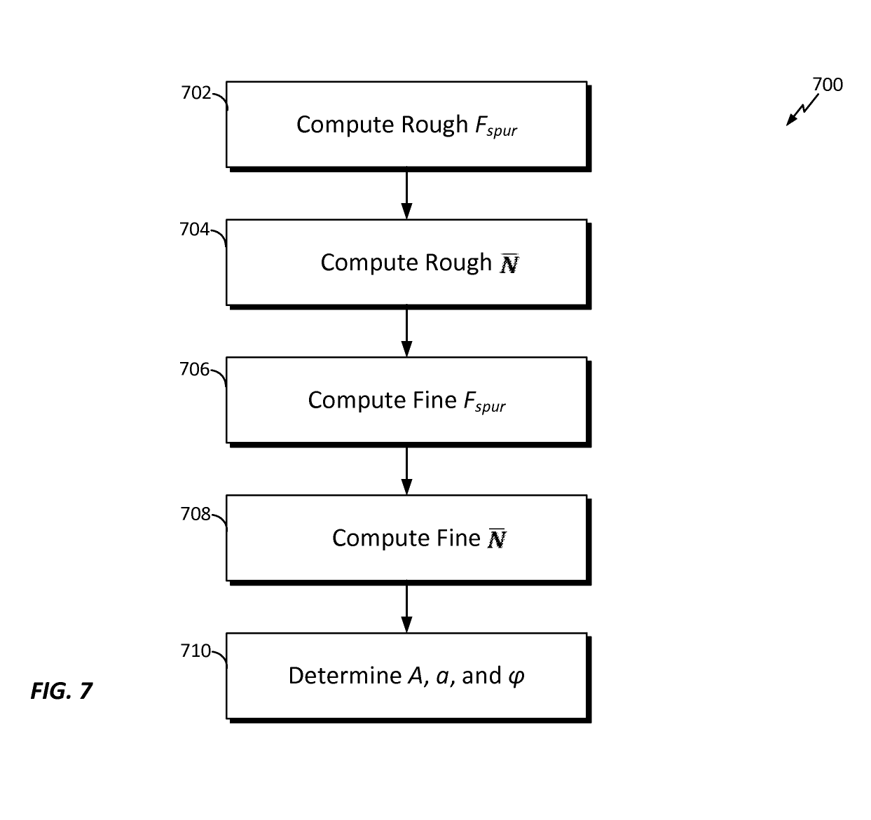

In this example, the searching algorithm includes the operations utilized for finding the values of Fₛₚᵤᵣ and N̅ that can minimize the cost function (8). Either one of the values of Fₛₚᵤᵣ and N̅ may be set to a predetermined value, and the value of the cost function (8) may be determined. This process may be performed iteratively until a desired value (e.g., a minimum value) of the cost function (8) is achieved, for example, as illustrated in FIG. 7 below.

In equation (8), R[k] is the FFT of the received signal data, X[k] is the theoretical expression of equation (3) with A=1. The use of ratios in equation (8) eliminates A from the equations, and the search variables become Fₛₚᵤᵣ (frequency variable) and N̅ (duration variable). The value kₘₐₓ is the FFT sample with the maximum spectrum value.

The search region for duration N̅ is 1: Nₜₒₜₐₗ, where, Nₜₒₜₐₗ is the number of samples used in the FFT. The search region for Fₛₚᵤᵣ is [F1 to F2] that is defined according to the following rule:

$$F 1 = {F}_{S} * \frac{{k}_{max}}{N} , \\ F 2 = R [ {k}_{max} + 1 ] > R [ {k}_{max} - 1 ] ? {F}_{S} * \frac{{k}_{max} + 1}{N} : {F}_{S} * \frac{{k}_{max} - 1}{N} .$$

F1 is the frequency where the peak occurs, and F2 is the equivalent frequency of the sample on the left or right depending on the relationship above.

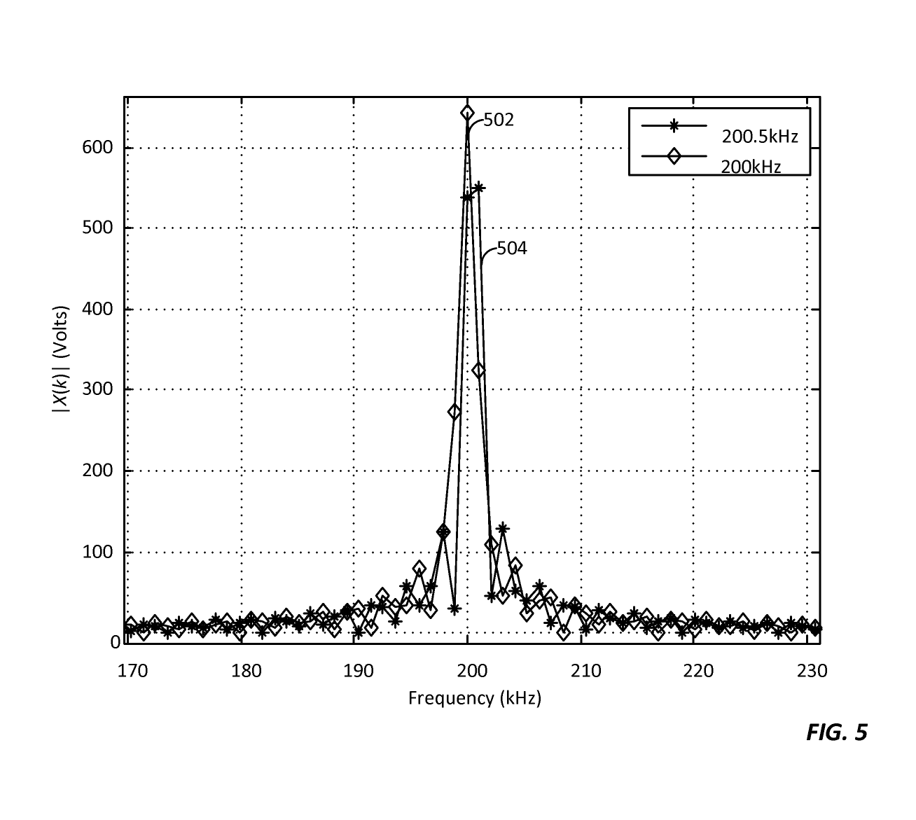

FIG. 5 is a graph illustrating the FFT of exemplary 200 kHz spur and 200.5 kHz spur sampled at 270.83×4 kHz (sampling frequency). Depending on the sampling frequency, the FFT may or may not sample the peak of the spurs. In the examples shown in FIG. 5, the 200 kHz spur 502 is sampled close to its peak, while the 200.5 kHz spur 504 is not. Therefore, in one aspect of the disclosure, the search region may be defined to be between the frequencies where the maximum sample and second highest sample lie. As illustrated in FIG. 5, if the peak of a spur (e.g., spur 502) gets sampled, the values to the left and right of the peak will be similar in magnitude. In one example, when the FFT is performed at Fₛ=270.833×4 (sampling frequency) and N=1024, the frequency resolution of the FFT is about 1.05 kHz. Therefore, the estimation error is about +/−500 Hz, if the sampled peak is taken as the spur frequency.

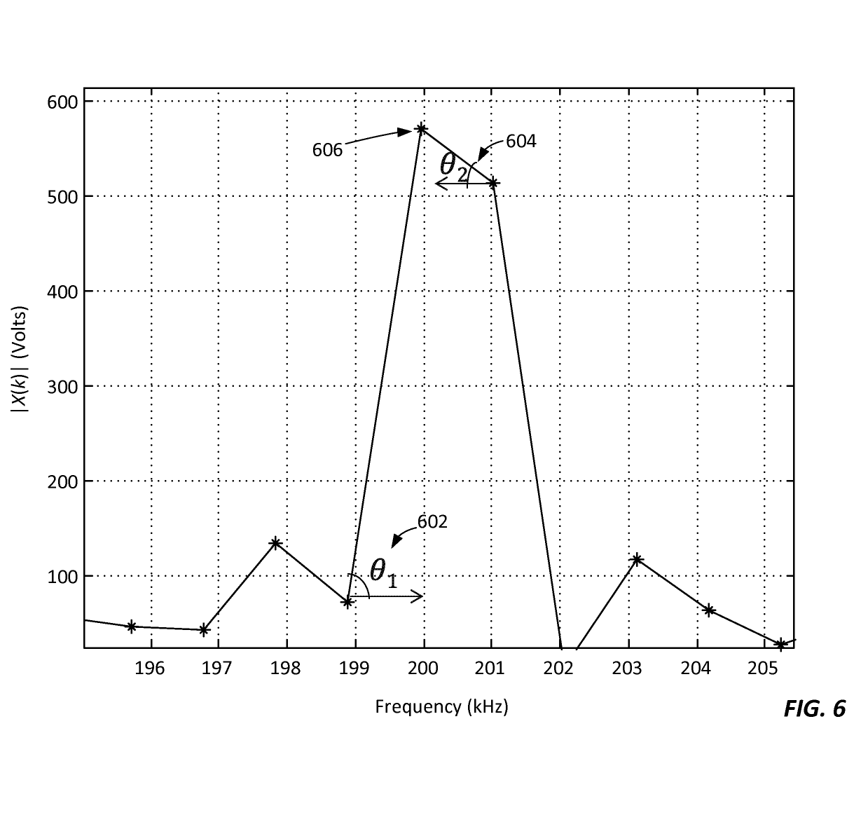

FIG. 6 is a graph illustrating the FFT of a 200.4 kHz spur sampled at a frequency of 270.833×4 kHz. However, in FIG. 6, the peak of the FFT is at about 200 kHz (kₘₐₓ), which is not the actual peak of the spur (200.4 kHz). In FIG. 6, the angle θ₁ corresponds to an angle formed by the max FFT sample kₘₐₓ and the adjacent FFT sample kₘₐₓ₋₁, and the angle θ₂ corresponds to an angle formed by the max FFT sample kₘₐₓ and the adjacent FFT sample kₘₐₓ₊₁. In one aspect of the disclosure, a weighted average of the angle θ₁ and angle θ₂ can provide a rough (coarse) spur frequency estimate. This rough estimated spur frequency can then be used with the cost function (8) to find a rough (coarse) value of the duration N̅ (rough estimated duration), which can be followed by a fine frequency search and a fine search for the duration N̅. The rough spur frequency estimate is less accurate than the fine spur frequency estimate. Similarly, the rough duration N̅ estimate is less accurate than the fine duration N̅ estimate.

FIG. 7 is a flow chart illustrating a spur parameters determination method 700 in accordance with some aspects of the disclosure. In one example, the method 700 may be performed using the apparatus 100 or any suitable device. The method 700 may be utilized to determine the five spur parameters A, Fₛₚᵤᵣ, N̅, a, and φ of the above described equations. It is assumed that the apparatus can receive a signal and perform an FFT on the signal samples to obtain the corresponding frequency domain data.

At block 702, the rough frequency estimation block 128 may be utilized to determine a rough estimated value (first estimated frequency) of the spur frequency Fₛₚᵤᵣ as a weighted average of a first angle (formed by the samples kₘₐₓ and kₘₐₓ₋₁) and a second angle (formed by the samples kₘₐₓ and kₘₐₓ₊₁) (e.g., angles θ₁ 602 and θ₂ 604 of FIG. 6) using equation (9) below, as an example.

$${F}_{spur\_rough} = - 0.5 * ( 1 - \frac{{θ}_{1}}{{θ}_{2} + {θ}_{1}} ) + F + 0.5 * ( 1 - \frac{{θ}_{2}}{{θ}_{2} + {θ}_{1}} ) \qquad ( 9 )$$

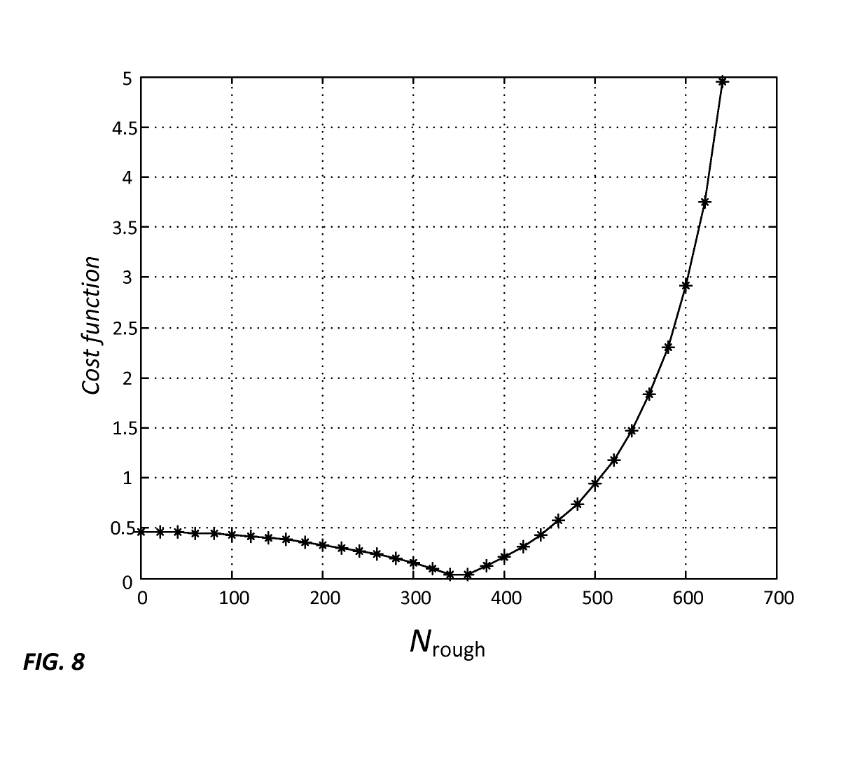

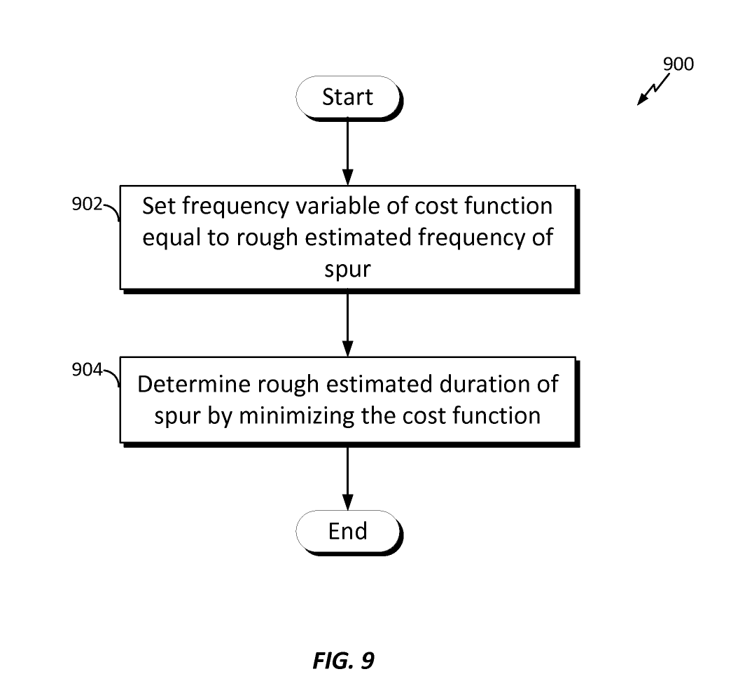

In equation (9), Fₛₚᵤᵣ_{_}_{rough} is the rough (course) estimated value of Fₛₚᵤᵣ, and F is the frequency of the sampled peak (e.g., peak 606 of FIG. 6). At block 704, the rough spur duration estimation block 122 may be utilized to determine a rough estimated value (first estimated duration) of N̅ based on the rough value of the spur frequency Fₛₚᵤᵣ_{_}_{rough} using, for example, the cost function (8) with a search size Nₜₒₜₐₗ and a step size N̅=20. Referring to FIG. 9, at block 902, the frequency variable of the cost function is set equal to the rough estimated value of Fₛₚᵤᵣ, which is determined in block 702. At block 904, the rough estimated duration of the spur is determined by minimizing the cost function (i.e., determining a minimum value of the cost function). In an illustrative example, FIG. 8 is a graph illustrating examples of rough estimated values of N̅ reaching a value of about 350 when the cost function (3) reaches a minimum value. In the graph of FIG. 8, the x-axis represents the rough value of N̅ while the y-axis represents the value of the cost function.

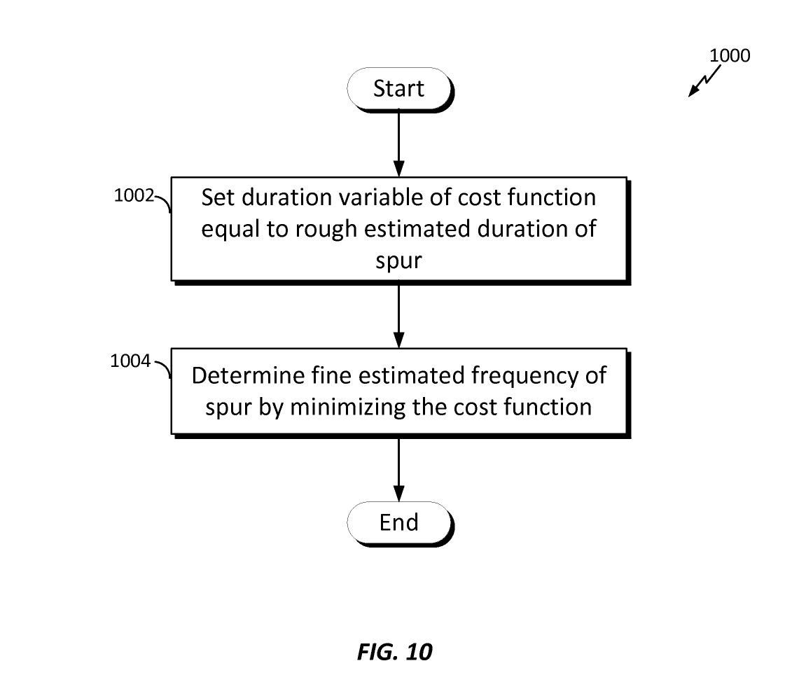

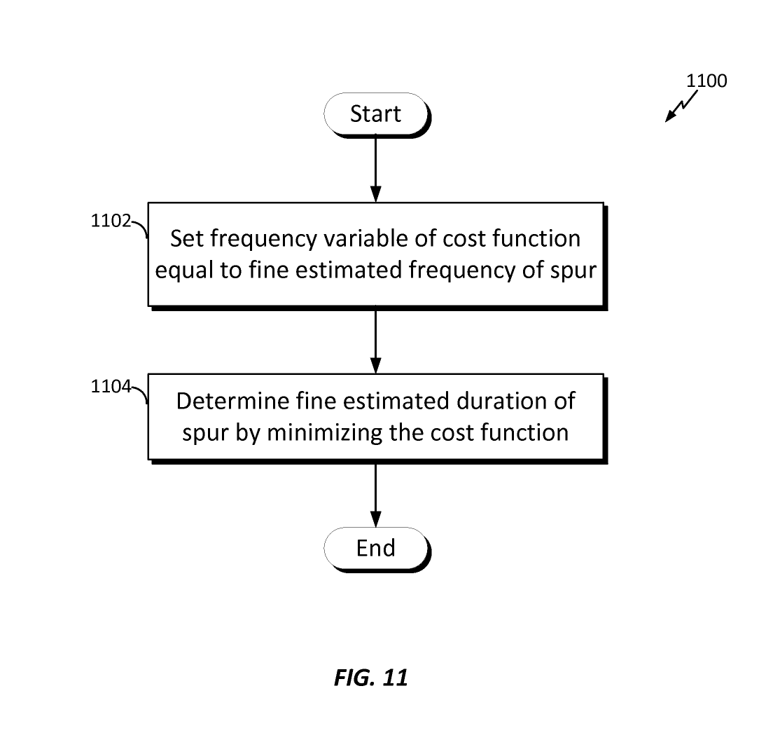

At block 706, using the rough estimated value of N̅, the fine spur frequency estimation block 126 may be utilized to determine a fine estimated value of Fₛₚᵤᵣ (second estimated frequency) using, for example, the cost function (8) with a search size of 500 Hz and a step size Fₛₚᵤᵣ=10 Hz. Referring to FIG. 10, at block 1002, the duration variable of the cost function is set equal to the rough estimated value of N̅ that is determined at block 704. Then, at block 1004, the fine estimated frequency of the spur is determined by minimizing the cost function (i.e., determining a minimum value of the cost function). At block 708, using the fine estimated value of Fₛₚᵤᵣ, the fine spur duration estimation block 124 may be utilized to determine the fine estimated value of N̅ (second estimated duration) using, for example, the cost function (8) with a search size of 100 and a step size N̅=1. Referring to FIG. 11, at block 1102, the frequency variable of the cost function is set equal to the fine estimated value of Fₛₚᵤᵣ, which is determined in block 706. At block 1104, the fine estimated duration of the spur is determined by minimizing the cost function (i.e., determining a minimum value of the cost function).

At block 710, utilizing the fine estimated values of Fₛₚᵤᵣ and N̅ determined at blocks 706 and 708, the ASP estimation block 130 may be utilized to determine the values of parameters A, a, and φ using Equations (3), (4), and (6) as follows.

$$A = \frac{\vert R [ {k}_{max} ] \vert}{\vert X [ {k}_{max} ] \vert}$$

$$α = \frac{1}{2} * ( \frac{mN}{π} - {\overline{N}}_{fine} + 1 )$$

$$ϕ = θ [ {k}_{max} ] - {πα}_{kmax} * ( \overline{N} - 1 + 2 α )$$

$${α}_{{k}_{max}} = \frac{{F}_{spur}}{{F}_{S}} - \frac{{k}_{max}}{N}$$

Where:
R[k] is the FFT of the received signal;
N̅ is the estimated duration;
Fₛₚᵤᵣ is the estimated spur frequency;
Fₛ is the sampling frequency;
N is the FFT widow size;
A is the estimated amplitude;
φ is the estimated initial phase offset; and
a is the estimated spur start location (e.g., a time offset from the start of a measurement period or window).

While the method 700 has been described with exemplary search sizes and step sizes for Fₛₚᵤᵣ and N̅, the method is not limited to those values. In other aspects of the disclosure, the search sizes and step sizes for Fₛₚᵤᵣ and N̅ may have other suitable values depending on for example the particular FFT performed, sampling frequency, and spur frequency.

As those skilled in the art will readily appreciate, various aspects described throughout this disclosure may be extended to any telecommunication systems, network architectures and communication standards. By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-11 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-11 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of determining spur parameters in a communication signal, comprising:
receiving a communication signal comprising a spur utilizing a communication interface;
determining a first estimated frequency of the spur;
determining a first estimated duration of the spur based on the first estimated frequency utilizing a searching algorithm;
determining a second estimated frequency of the spur based on the first estimated duration utilizing the searching algorithm;
determining a second estimated duration of the spur based on the second estimated frequency utilizing the searching algorithm; and
determining at least one of an amplitude, a start location, or a phase offset of the spur based on the second estimated frequency and the second estimated duration.

2. The method of claim 1, wherein the searching algorithm comprises a cost function with a frequency variable and a duration variable.

3. The method of claim 2, wherein the determining the first estimated duration comprises determining a minimum value of the cost function while setting the frequency variable equal to the first estimated frequency of the spur.

4. The method of claim 2, wherein the determining the second estimated frequency of the spur comprises determining a minimum value of the cost function while setting the duration variable equal to the first estimated duration.

5. The method of claim 2, wherein the determining the second estimated duration comprises determining a minimum value of the cost function while setting the frequency variable equal to the second estimated frequency of the spur.

6. The method of claim 1, wherein the first estimated frequency of the spur is less accurate than the second estimated frequency of the spur.

7. The method of claim 1, wherein the first estimated duration of the spur is less accurate than the second estimated duration of the spur.

8. The method of claim 1,
wherein fast Fourier transform (FFT) samples of the communication signal comprise a maximum FFT sample kₘₐₓ, a first adjacent FFT sample kₘₐₓ₋₁, and a second adjacent FFT sample kₘₐₓ₊₁; and
wherein the determining the first estimated frequency of the spur comprises determining the first estimated frequency as a weighted average of a first angle based on the maximum FFT sample kₘₐₓ and the first adjacent FFT sample kₘₐₓ₋₁, and a second angle based on the maximum FFT sample kₘₐₓ and the second adjacent FFT sample kₘₐₓ₊₁.

9. An apparatus comprising:
means for receiving a communication signal comprising a spur;
means for determining a first estimated frequency of the spur;
means for determining a first estimated duration of the spur based on the first estimated frequency utilizing a searching algorithm;
means for determining a second estimated frequency of the spur based on the first estimated duration utilizing the searching algorithm;
means for determining a second estimated duration of the spur based on the second estimated frequency utilizing the searching algorithm; and
means for determining at least one of an amplitude, a start location, or a phase offset of the spur based on the second estimated frequency and the second estimated duration.

10. The apparatus of claim 9, wherein the searching algorithm comprises a cost function with a frequency variable and a duration variable.

11. The apparatus of claim 10, wherein the means for determining the first estimated duration is configured to determine a minimum value of the cost function while setting the frequency variable equal to the first estimated frequency of the spur.

12. The apparatus of claim 10, wherein the means for determining the second estimated frequency of the spur is configured to determine a minimum value of the cost function while setting the duration variable equal to the first estimated duration.

13. The apparatus of claim 10, wherein the means for determining the second estimated duration is configured to determine a minimum value of the cost function while setting the frequency variable equal to the second estimated frequency of the spur.

14. The apparatus of claim 9, wherein the first estimated frequency of the spur is less accurate than the second estimated frequency of the spur.

15. The apparatus of claim 9, wherein the first estimated duration of the spur is less accurate than the second estimated duration of the spur.

16. The apparatus of claim 9,
wherein fast Fourier transform (FFT) samples of the communication signal comprises a maximum FFT sample kₘₐₓ, a first adjacent FFT sample kₘₐₓ₋₁, and a second adjacent FFT sample kₘₐₓ₊₁, and
wherein the means for determining the first estimated frequency of the spur is configured to determine the first estimated frequency as a weighted average of a first angle based on the maximum FFT sample kₘₐₓ and the first adjacent FFT sample kₘₐₓ₋₁, and a second angle based on the maximum FFT sample kₘₐₓ and the second adjacent FFT sample kₘₐₓ₊₁.

17. An apparatus comprising:
a communication interface;
a computer-readable medium comprising a spur parameters estimation code; and
at least one processor coupled to the communication interface and the computer-readable medium,
wherein the at least one processor when executing the spur parameters estimation code, is configured to:
receive a communication signal comprising a spur utilizing the communication interface;
determine a first estimated frequency of the spur;
determine a first estimated duration of the spur based on the first estimated frequency utilizing a searching algorithm;
determine a second estimated frequency of the spur based on the first estimated duration utilizing the searching algorithm;
determine a second estimated duration of the spur based on the second estimated frequency utilizing the searching algorithm; and
determine at least one of an amplitude, a start location, or a phase offset of the spur based on the second estimated frequency and the second estimated duration.

18. The apparatus of claim 17, wherein the searching algorithm comprises a cost function with a frequency variable and a duration variable.

19. The apparatus of claim 18, wherein the at least one processor when executing the spur parameters estimation code, is further configured to:
minimize the cost function while setting the frequency variable equal to the first estimated frequency of the spur.

20. The apparatus of claim 18, wherein the at least one processor when executing the spur parameters estimation code, is further configured to:
minimize the cost function while setting the duration variable equal to the first estimated duration of the spur.

21. The apparatus of claim 18, wherein the at least one processor when executing the spur parameters estimation code, is further configured to:
minimize the cost function while setting the frequency variable equal to the second estimated frequency of the spur.

22. The apparatus of claim 17, wherein the first estimated frequency of the spur is less accurate than the second estimated frequency of the spur.

23. The apparatus of claim 17, wherein the first estimated duration of the spur is less accurate than the second estimated duration of the spur.

24. The apparatus of claim 17,
wherein fast Fourier transform (FFT) samples of the communication signal comprises a maximum FFT sample kₘₐₓ, a first adjacent FFT sample kₘₐₓ₋₁, and a second adjacent FFT sample kₘₐₓ₊₁, and
wherein the at least one processor when executing the spur parameters estimation code, is further configured to determine the first estimated frequency as a weighted average of a first angle based on the maximum FFT sample kₘₐₓ and the first adjacent FFT sample kₘₐₓ₋₁, and a second angle based on the maximum FFT sample kₘₐₓ and the second adjacent FFT sample kₘₐₓ₊₁.

25. A computer-readable medium comprising code for causing an apparatus to determine spur parameters in a communication signal, the code causing the apparatus to:
receive a communication signal comprising a spur utilizing a communication interface;
determine a first estimated frequency of the spur;
determine a first estimated duration of the spur based on the first estimated frequency utilizing a searching algorithm;
determine a second estimated frequency of the spur based on the first estimated duration utilizing the searching algorithm;
determine a second estimated duration of the spur based on the second estimated frequency utilizing the searching algorithm; and
determine at least one of an amplitude, a start location, or a phase offset of the spur based on the second estimated frequency and the second estimated duration.

26. The computer-readable medium of claim 25, wherein the searching algorithm comprises a cost function with a frequency variable and a duration variable.

27. The computer-readable medium of claim 26, wherein for determining the first estimated duration, the code further causes the apparatus to determine a minimum value of the cost function while setting the frequency variable equal to the first estimated frequency of the spur.

28. The computer-readable medium of claim 26, wherein for determining the second estimated frequency of the spur, the code further causes the apparatus to determine a minimum value of the cost function while setting the duration variable equal to the first estimated duration.

29. The computer-readable medium of claim 26, wherein for determining the second estimated duration, the code further causes the apparatus to determine a minimum value of the cost function while setting the frequency variable equal to the second estimated frequency of the spur.

30. The computer-readable medium of claim 25,
wherein fast Fourier transform (FFT) samples of the communication signal comprise a maximum FFT sample kₘₐₓ, a first adjacent FFT sample kₘₐₓ₋₁, and a second adjacent FFT sample kₘₐₓ₊₁; and
wherein for determining the first estimated frequency of the spur, the code further causes the apparatus to determine the first estimated frequency as a weighted average of a first angle based on the maximum FFT sample kₘₐₓ and the first adjacent FFT sample kₘₐₓ₋₁, and a second angle based on the maximum FFT sample kₘₐₓ and the second adjacent FFT sample kₘₐₓ₊₁.
